(19) United States
(12) Patent Application Publication
(10) Pub. No.: US 2025/0189139 A1
(43) Pub. Date: Jun. 12, 2025

(54) Modular Fireplace Insert Assembly and Method

(71) Applicants: Jackey Chu, Kowloon Bay (HK); Bee Chu, Kowloon Bay (HK)

(72) Inventors: Jackey Chu, Kowloon Bay (HK); Bee Chu, Kowloon Bay (HK)

(21) Appl. No.: 18/530,776

(22) Filed: Dec. 6, 2023

(51) Int. Cl. F24C 7/00; F21S 10/04; F24C 7/08

(52) U.S. Cl. CPC F24C 7/004; F21S 10/046; F24C 7/081

(57) ABSTRACT

A modular electric fireplace insert includes a housing comprising a bottom panel, left and right side panels, a back panel, and a heater glass front panel, a heater unit, a fireplace grate with fire logs, a flame simulator unit, fake ash components and a remote control. The modular electric fireplace insert may be disassembled for transport and storage, and may be fully assembled prior to installation into a fireplace, cabinet, wall, or the like. In one embodiment, the heater unit and the housing include a sliding mechanism, so that the heater unit may be slidably installed and removed from the housing after assembly and installation of the fireplace insert in a fireplace, cabinet, or the like,

### FIELD OF THE INVENTION

The present invention is directed to electric modular fireplace inserts. More specifically, the present invention includes an electric modular fireplace insert having a housing, heater and flame generator light source that is designed to simulate a wood-burning fire, and which is shipped in a disassembled state, and then assembled prior to insertion into a fireplace.

### BACKGROUND OF THE INVENTION

Many different types of fireplaces are commonly installed in homes and other types of dwellings as a means to provide heat, and to create a warm ambience. Traditionally, such fireplaces have largely comprised wood-burning fireplaces and gas-burning fireplaces. However, in recent years, electric fireplaces have become more popular for various reasons, including the fact that they tend to be safer, easier to maintain, and because advances have been made allowing electric fireplaces to more closely resemble traditional wood-burning fireplaces.

One issue with some of the recently developed electric fireplace modules is that they are factory assembled and shipped in the assembled state, which occupies a lot of shipping space, and makes shipping and transport expensive and cumbersome. Alternatively, some modular fireplaces are shipped in an extremely disassembled state, which does ease the expense, size and burden of shipping and transportation, but requires significant time and effort for a purchaser to assemble and install, once the package has arrived with the disassembled modular fireplace insert components. Examples of various modern electric modular fireplace assemblies are outlined in the following documents, and these documents are hereby incorporated by reference herein, in their entireties:

### U.S. Pat. No. 77,703,12B2 Flame Stimulating Assembly

A flame simulating assembly for providing one or more images of flames. The flame simulating assembly includes one or more light sources for producing the image of flames and a screen with a front surface and positioned in a path of light from the light source. The screen is adapted for transmission of the images of flames through the screen. The assembly also includes one or more simulated interior fireplace walls positioned behind the screen, a first simulated fuel bed positioned in front of the screen and a second simulated fuel bed positioned behind the screen and at least partially viewable through the screen. The screen is adapted to permit observation of at least part of the simulated interior fireplace wall.

### U.S. Pat. No. 10,371,333 Flame Simulating Assembly for Simulated Fireplaces Including an Integrated Flame Screen and Ember Bed

A flame simulating assembly is provided with a reflected flickering light that includes only one light source. Light from the light source passes though a rotating flicker element onto an angled reflector, or mirror, that reflects light up onto a simulated fuel bed and the some of the light is reflected off of the flicker elements towards a flame screen to create a simulated flame. The clipping flicker elements creates a fluttering light effect due to the flicker elements “intermittently dipping” into the light path. This fluctuating light is reflected onto the logs and ember bed in front and creates a dancing effect, which simulates glowing embers.

### U.S. Pat. No. 11,619,390 Modular Assembly for Electric Fireplace

An electric fireplace includes a fireplace housing and an electrical insert. The fireplace housing includes a base panel having a base opening, a back panel, and at least one side panel. The electrical insert is sized and shaped to fit and be supported and retained within the base opening. Additionally, the electrical insert can include a heater, and a controller including a processor that is configured to control operation of the electric fireplace. Further, each of the base panel, the back panel and the at least one side panel can be manufactured and installed independently of one another. The fireplace housing can further include a front frame that is manufactured and installed independently of each of the base panel, the back panel and the at least one side panel. Still further, at least one of the back panel and the at least one side panel can be foldable.

### U.S. Patent Publication No. 20030041491 Flame Simulation Apparatus and Method

A flame simulation apparatus for use in electric fireplaces is disclosed. The flame simulation apparatus is disposed within a fireplace enclosure to simulate a natural fire. The flame simulation apparatus includes a flame element and a device to alter the position of the flame element relative to a fixed position. Methods for simulating a natural fire are also disclosed.

### U.S. Patent Publication No. 20030126775 Simulated Log Burning Fireplace Apparatus

The simulated log fireplace apparatus having a housing forming a fire box having a back wall, bottom wall, top wall, two side walls and an open front side containing at least one artificial log and simulated flame sheets therein. A blower directs air on to the simulated flame sheets to simulate the movement of real flames. A colored light source provides the color of real flames. The light source and blower are adjustable from a control panel under a louver panel in a top front of the apparatus. The artificial log may include a translucent base log on an ember bed with a white light source beneath the translucent log. A window log having an aperture simulate a burning core of a real log. A transparent partition that has a partially opaque area just above the simulated flame sheets helps to further simulate appearance and depth of a real fireplace. The apparatus may include an electric heater with blower to provide the heat of a real fire. A crackle box may be optionally included to provide the sound of burning wood. Decorative simulated brick panels may be placed on back and side walls. Additional features of a conventional fireplace, including a metal screen, glass doors, vents and louvers are provided.

### U.S. Patent Publication No. 20030156828 Fireplace With Simulated Flame

A fireplace assembly is provided by which the image of a working combustible fuel-burning fireplace may be simulated. The fireplace assembly includes a housing having a lenticular panel assembly including a moving simulation of at least flames for generating the appearance of simulated flames within the housing. The lenticular panel assembly includes a means for mounting and rotating the panel through an arc to provide the illusion of moving flames within the fireplace assembly.

### U.S. Patent Publication No. 20040264949 Fireplace

An electric fireplace with artificial logs and lights simulating burning logs and flames is disclosed. The fireplace comprises of a housing with a top compartment and a bottom compartment. Within the top compartment is affixed an electric heating element and an exhaust fan to eject the heat from the heating element toward the front of the housing. Artificial logs and lights to simulate burning logs and flame are contained within the bottom compartment wherein the appearance of the lights and its movements are controlled by an electric motor within the bottom compartment. A set of control is attached to the housing for controlling the electric heater and the artificial fireplace. When the fireplace is electrically energized and the controls are activated, the heating element generates heat which are delivered to the user by the exhaust fan. The artificial logs will appear to be burning with realistic moving sparks and dancing flames.

### U.S. Patent Publication No. 20050086841 Flame Simulating Apparatus

A flame simulating apparatus to simulate flames emanating from a wood or fossil fuel burning fire. The flame simulating apparatus includes a light source, a light reflecting element, and a fire simulation screen. The light reflecting element produces a moving and generally random pattern of reflected light when light is cast upon it by the light source. The fire simulation screen has the image of a fire thereon and is positioned so that reflected light from the light reflecting element is cast upon its rear surface. The fire simulation screen includes at least one portion that is at least partially translucent such that light cast upon the partially translucent portion by the light reflecting element is diffused and at least partially passes through the translucent portion to present a moving flame image when viewed from a position in front of the fire simulation screen.

### U.S. Patent Publication No. 20080013931 Electric Fireplace

An electric fireplace includes a fireplace housing having a housing first and second side walls and a housing top wall, a housing floor, a housing back wall, and a housing open end opposite the housing back wall; a flame simulator mounted inside the housing; a diffusion screen removably mounted upright within the housing in front of the flame simulator; an ember bed simulating the appearance of fireplace fuel such as fire wood, embers or coal, and removably mounted inside the housing in front of the flame simulator, so that removal of the ember bed and the flame cutout panel provides access to the flame simulator from the housing open end; and a hot air generator removably mounted inside the housing to be accessible from the housing open end.

### U.S. Patent Publication No. 20090126241 Electric Fireplace Insert and Methods of Use

An electric fireplace insert and methods for simulating the light and sound effects of real burning fuel utilize one or more of a light emitting diode (LED) down lighting system, an LED flame light system, and an LED ember bed light system which work together to make the electric fireplace insert more closely resemble the appearance and sounds of a traditional fuel-burning fireplace. By simultaneously and independently changing the brightness of several groups of LEDs of the LED down lighting system, a shadow motion effect of ambient light similar to that seen in a traditional fuel-burning fireplace can be simulated. By simultaneously and independently changing the brightness of several groups of LEDs of the LED ember bed lighting system, a rolling motion, or side-to-side, effect of light inside the ember bed can be simulated. The flashing of the LEDs of the LED ember bed lighting system and/or the LED simulated fuel lighting system can also be synchronized by the CPU with crackling sounds that may be stored on a memory chip and emitted by the audio speaker to simulate the sparks and associated crackling noise of burning fuel. The electric fireplace insert can be included in a fireplace housing having a front portion to which can be attached one of a set of different-looking, removable, decorative face plates.

### U.S. Patent Publication No. 20140044423 Modular Electric Wall Heater

A modular electric wall heater comprises an upper main box components, a lower main box component, a left side panel component, a right side panel component, a flame simulator unit, a fake ash component, a front panel component, and a rear panel component; the left side panel component and the right side panel component connect with the upper main box component and the lower main box component to form an enclosure; the flame simulator unit situates inside of the enclosure and is connected with the left side and right side panel component; the ashes component situates inside of the enclosure, and on the top of the and connect to a bottom panel of the lower main box component, the frontal panel component is situate on the frontal opening of the enclosure and the rear panel component is situate on the rear opening of the enclosure.

### U.S. Patent Publication No. 20170261212 Electric Fireplace Insert With Interchangeable Firebox Modules

An electric fireplace insert assembly includes a fireplace insert, an ember bed module and a candelabra module. The ember bed module and the candelabra module are interchangeably installed within a firebox cavity defined within the front of the fireplace insert. The candelabra module may be separately operable from the fireplace insert, providing an additional decorative display. The electric fireplace insert may further include a projector module configured to project a simulated flame onto a rear wall of the fireplace cavity. The electric fireplace insert further includes a heat/blower unit to provide space heater functionality and a flame simulation assembly.

### U.S. Patent Publication No. 20180347818 Fireplace Cavity Insert

A fireplace cavity insert provides still and video images appearing to emanate from within the insert.

### U.S. Patent Publication No. 20210372627 Modular Fireplace Insert

Provided is an electric fireplace system for simulating the light and sound effects of real burning fuel. The system includes modular components that are configured to be packaged, shipped, stored and assembled in a deconstructed state. The electric fireplace system comprising a modular fireplace insert comprising an insert housing that defines a cavity. A simulated fuel source for simulating a fire display, the simulated fuel source includes a first housing that is configured to be positioned in the insert housing. A heater assembly for generating warm air, the heater assembly including a second housing that is configured to be positioned in the insert housing at a positioned spaced from and above the simulated fuel source within the cavity of the insert housing.

### U.S. Patent Publication No. 20210404667 Modular Assembly for Electric Fireplace

An electric fireplace includes a fireplace housing and a heater assembly that is configured to generate heated air. The heater assembly is configured to be installed substantially within the fireplace housing. The heater assembly includes a heater body, a first grill cover that is selectively couplable to the heater body, and a second grill cover that is alternatively selectively couplable to the heater body. The first grill cover has a first cover length, and the second grill cover has a second cover length that is different than the first cover length. The heater assembly is selectively positionable within a cabinet having a structural opening, and a center shelf that defines at least a portion of an upper side of the structural opening. The heater assembly is installed substantially adjacent to the center shelf.

### U.S. Patent Publication No. 20220299209 Ready to Assemble Furniture and Fireplace Insert

The present disclosure provides a novel ready to assemble simulated fireplace insert kit which can be combined with a pre-built furniture piece, or a ready to assemble furniture piece to provide a unique solution in the ready to assemble furniture product category. The ready to assemble simulated fireplace insert is broken down into individual components that can more easily be packed and shipped in a flat format and assembled by the end user. In some embodiments, certain components may be shared across different width insert assemblies to reduce costs.

### SUMMARY OF THE INVENTION

The present invention, in one embodiment, includes a modular electric fireplace insert including a housing comprising a bottom panel, left and right side panels, a back panel, and a heater glass front panel, a heater unit, a fireplace grate with fire logs, a flame simulator unit, fake ash components and a remote control. In some embodiments, a cabinet is included, which may be assembled from various components including bottom, top and side panels, as well as shelves, as desired. The modular electric fireplace insert may be assembled and installed into an opening formed in the cabinet, or may be installed directly into a fireplace in a home or dwelling.

The two primary electrical components are the heater unit and the flame simulator unit. These units may be separated from one another, or may be combined into a single component. For example, in some embodiments, the heater unit may be disposed within an upper portion of the housing, while the flame simulator unit may be installed on or adjacent to the bottom panel of the housing. In this arrangement, the heater unit and the flame simulator unit may be electrically connected by any suitable electrical cord that may be plugged into and unplugged from either or both the heater unit and the flame simulator unit. One advantage of this embodiment is that the various components, including the heater unit and the flame simulator unit, may be easily removed and replaced in the event of a malfunction of either component, without disturbing the other components during the repair and replacement process.

Alternatively, the heater unit and the flame simulator unit may be combined into a single component or unit that is preferably positioned within the housing on or adjacent to the bottom panel, and may be hardwired together, so that a user is not required to connect the heater unit and the flame simulator unit as part of the assembly and installation process.

### DESCRIPTION OF THE DRAWINGS

These and other features, aspects, and advantages of the present invention will become better understood with regard to the following description and accompanying drawings where:

FIG. 1 is a perspective view of one embodiment of a modular electric fireplace insert;

FIG. 2 is a perspective exploded view of one embodiment of a modular electric fireplace insert, showing a housing formed from a bottom panel, a right side panel, a left side panel, a back panel and a front glass panel, and further showing a heater unit electrically connected to a fire simulator unit;

FIG. 3 is a perspective view of one embodiment of a heater unit electrically connected to a fire simulator unit;

FIG. 4 is a perspective exploded view of one embodiment of a modular electric fireplace insert, showing a housing in an assembled state, and further showing a heater unit that is electrically connected to a fire simulator unit;

FIG. 5 is a perspective exploded view of one embodiment of a modular electric fireplace insert, showing a partially assembled housing, wherein the bottom panel, right side panel, left side panel in an assembled state, and showing the rear panel in a detached state, wherein the heater unit and the fire simulator unit are installed within the housing;

FIG. 6 is a perspective exploded view of one embodiment of a flame simulator unit, showing a base plate, a rotating flame simulating mechanism with reflectors attached to a rotating axle, a motor for rotating the axle, a cover plate, strip lights, a grate, and simulated fire logs, along with assembly hardware.

FIG. 7 is a perspective exploded rear view of one embodiment of a heater unit and a flame simulator unit, wherein both the heater unit and the flame simulator unit are connected to a control unit, which is used to control components of the heater unit and the flame simulator unit;

FIG. 8 is a front exploded view of one embodiment of a heater unit and a flame simulator unit, wherein both the heater unit and the flame simulator unit are connected to a control unit, which is used to control components of the heater unit and the flame simulator unit;

FIG. 9 is a perspective exploded front view of one embodiment of a heater unit and a flame simulator unit, wherein both the heater unit and the flame simulator unit are connected to a control unit, which is used to control components of the heater unit and the flame simulator unit;

FIG. 10 is a perspective rear view of another embodiment of a heater unit having a pair of slider brackets attached to either side thereof;

FIG. 11 is a perspective exploded rear view of another embodiment of a heater unit that is in slidable engagement with a cabinet, wherein the heater unit includes a pair of slider brackets affixed to either side thereof, and the slider brackets are in slidable engagement with a pair of track brackets affixed to the underside of the top panel of a cabinet; and

FIG. 12 is perspective transparent rear view of another embodiment of a heater unit that is in slidable engagement with a cabinet, wherein the heater unit includes a pair of slider brackets affixed to either side thereof, and the slider brackets are in slidable engagement with a pair of track brackets affixed to the underside of the top panel of a cabinet.

### DETAILED DESCRIPTION OF THE INVENTION

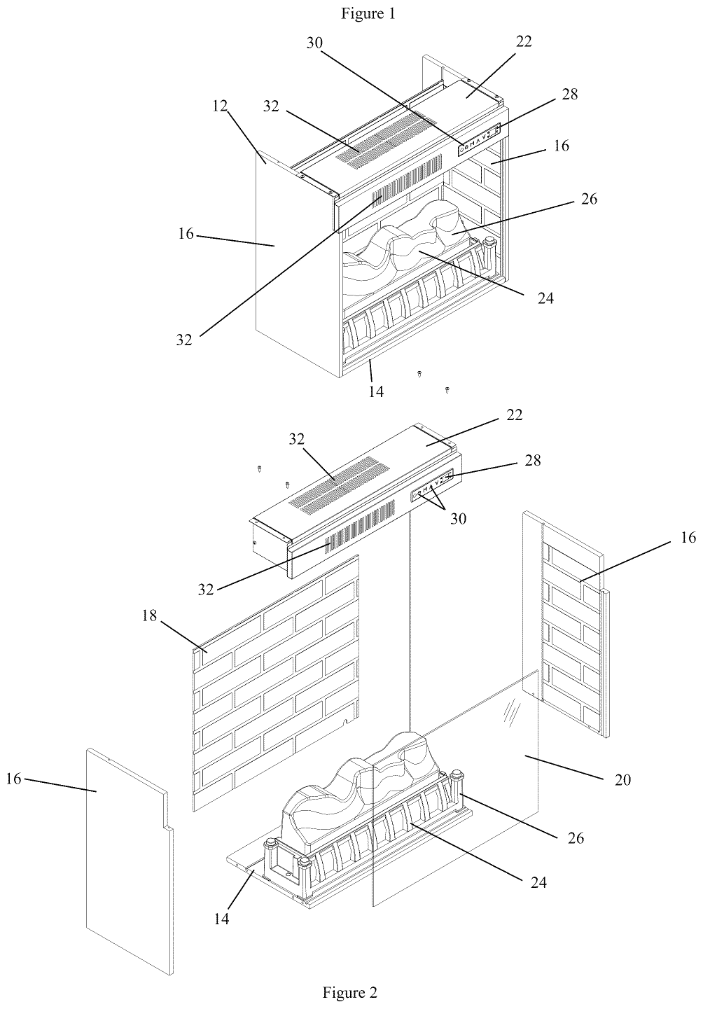

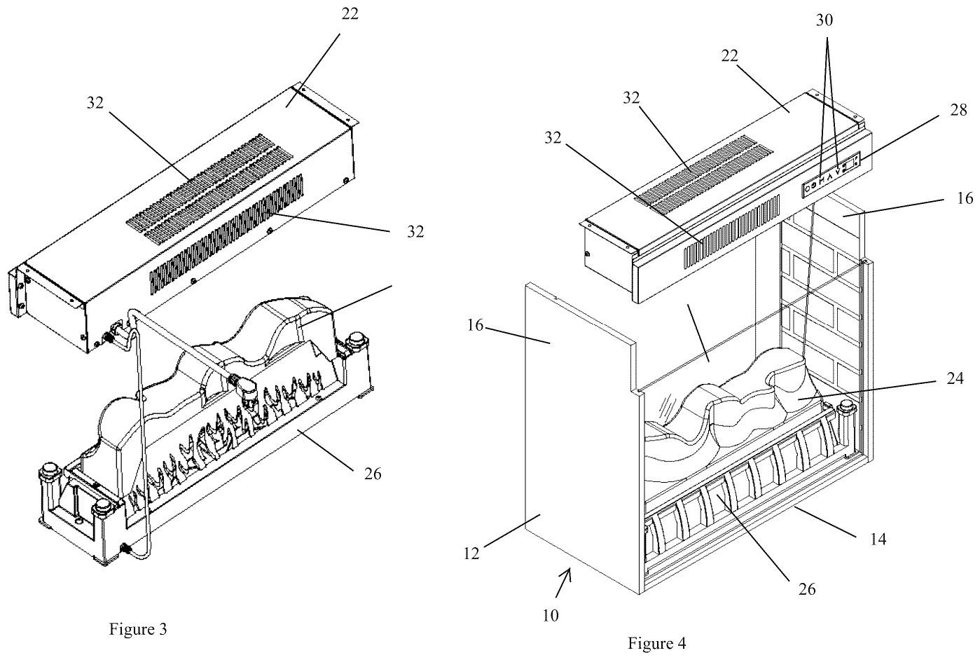

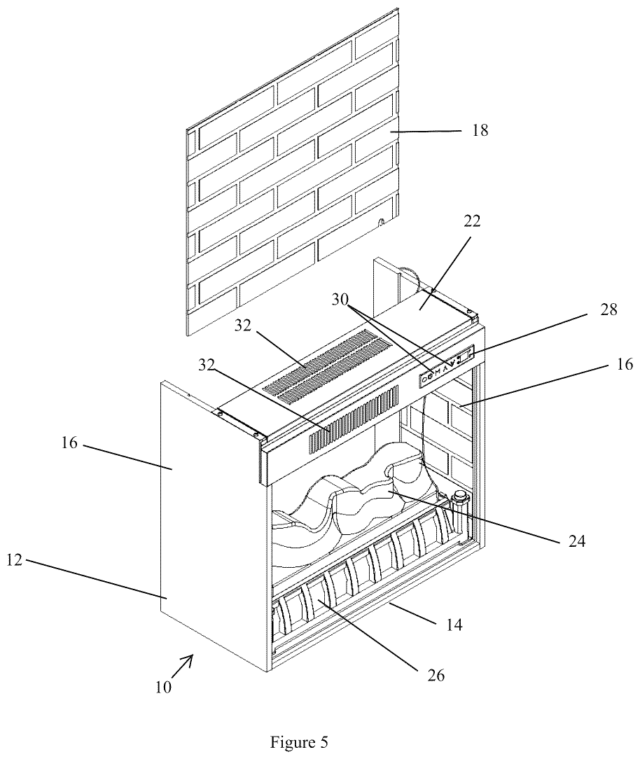

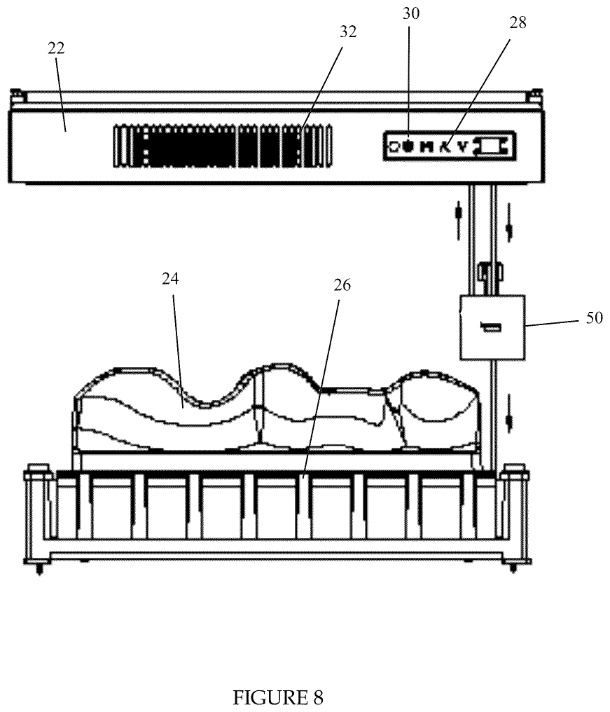

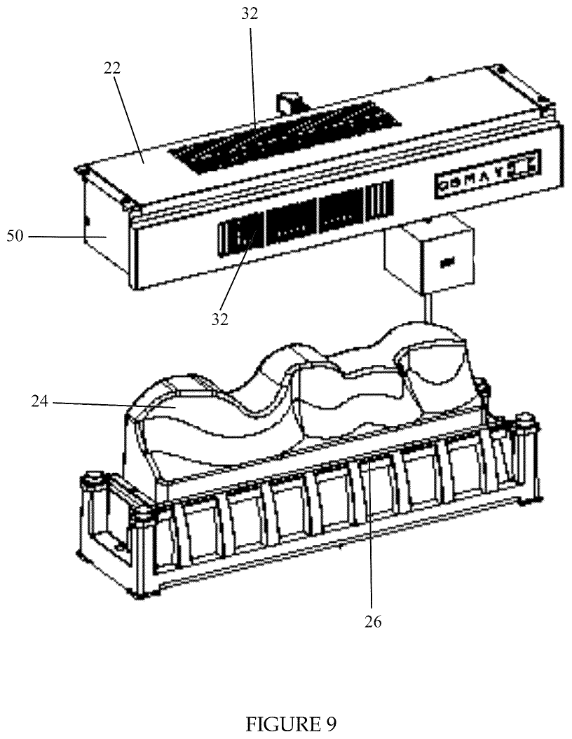

As shown in FIGS. 1-9, the present invention includes, in one embodiment, a modular electric fireplace insert 10 that preferably includes a housing 12 comprising a bottom panel 14, left and right side panels 16, a back panel 18, and a heater glass front panel 20, a heater unit 22, a fireplace grate with fire logs 24, a flame simulator unit 26, fake ash components and a remote control. In some embodiments, a cabinet is included, which may be assembled from various components including bottom, top and side panels, as well as shelves, as desired. The modular electric fireplace insert 10 may be shipped in a partially disassembled state to an end user, and then may be assembled and installed into an opening formed in the cabinet, or may be installed directly into a fireplace in a home or dwelling.

### Housing

The housing 12 preferably includes a bottom panel 14, a pair of side panels 16 (right side panel and a left side panel), a back panel 18, and a heater glass front panel 20. The housing components may be shipped in a disassembled state, and may be easily assembled by an end user. The housing components may be assembled in any suitable manner, preferably including with screws and pre-drilled holes for receiving the screws, or the housing components may include snap-fit components that allow for quick and easy assembly and disassembly, if necessary. In some embodiments, the top of the housing may remain open with no panels to allow ventilation and air circulation, particularly in embodiments where the heater unit 22 is installed in the upper portion of the housing 12. In other embodiments, a top panel 50 may be included, as well, and assembled together with the sides using screws, snap fit mechanisms, or in any other suitable manner.

### Heater Unit

The heater unit 22 is positioned within the housing 12, and is used to heat and circulate air, and preferably includes a heating element, a fan and an electronic control unit that allows a user to control the temperature of the heating element, as well as the speed of the fan. In some embodiments, the heater unit 22 may further include a front control panel 28 with control buttons 30, so that a user may have touch-button access on the control panel 28. The heater unit 22 may also include, or may be operably connected to, a wireless receiver for receiving commands from a remote control device. The heater unit 22 also preferably includes one or more air vents 32 that allow the warm air to flow therethrough, in order to circulate air into the room where the modular electric fireplace insert 10 is installed.

The electronic control unit 50 may include a main control circuit board, a control keyboard or panel, the receiver for a remote control, a power cord or power cord slot, a Negative Temperature Coefficient Thermistor (NTC), and an air filter in operable communication with the air vents 32 or outlets. Further, the electronic control unit may also function as, or be operatively connected to, a timer or timing device, so that a user may set the electronic controller to turn the heater unit 22 and flame simulator unit 26 on and off at predetermined times, or for periods of time selected by a user. The electronic control unit 50 may also include controls for adjusting the temperature and fan speed of the heater unit 22, as well as controls for adjusting various effects of the flame simulator unit 26, such as brightness, color, flame simulation lighting patterns (for example, to simulate a slow-burning, low intensity fire, or to simulate a fast-burning, high intensity fire), and the like.

Other embodiments of heater units are shown and described in the references cited hereinabove and are known in the art, and may be incorporated into the present modular electric fireplace insert.

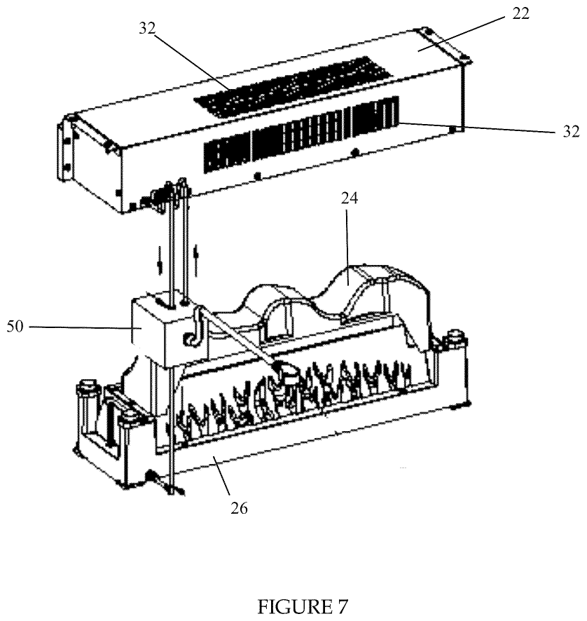

Additionally, it should be understood that the electronic controller (or control box) 50 may be a separate component from the heater unit and the flame simulator unit, as shown in FIGS. 7-9. In this embodiment, the electronic controller unit 50 is wired to both the heater unit 22 and the flame simulator unit 26 to control various components of both, as set forth herein, and may also be connected to a power source, so that the electronic controller 50 distributes power to the heater unit 22 and the flame simulator unit 26.

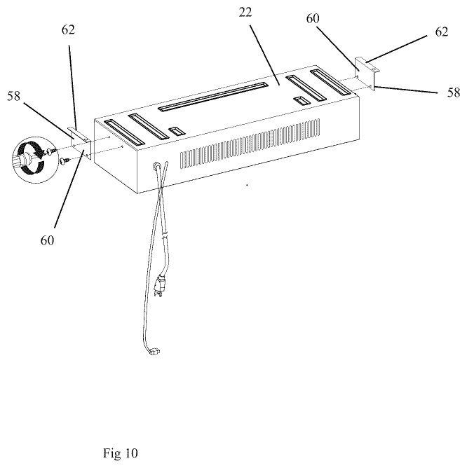

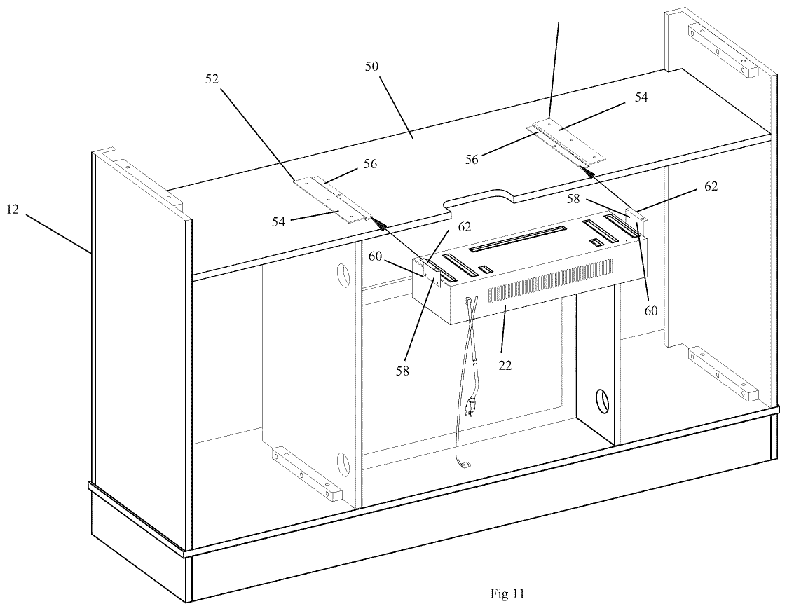

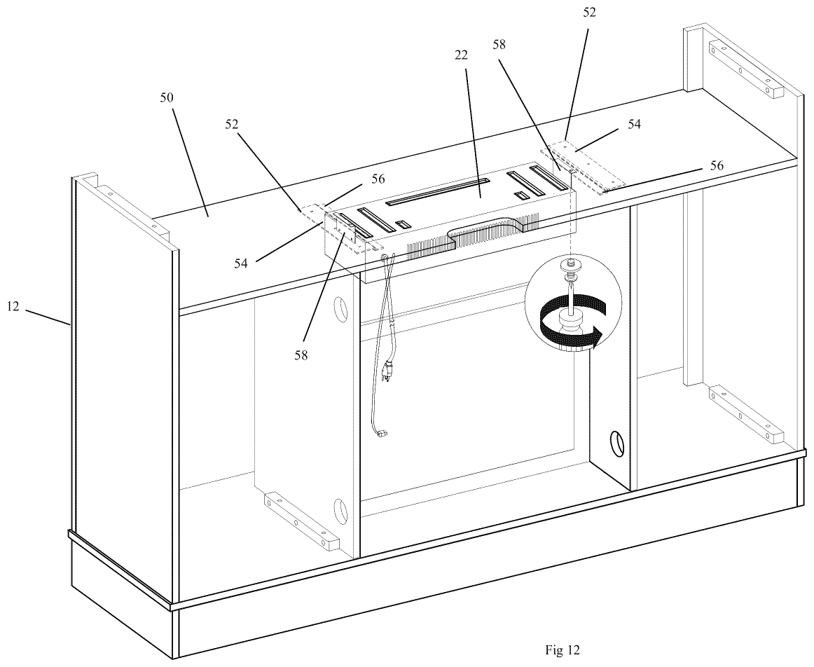

In another embodiment, the heater unit 22 may be inserted into the housing 12 by sliding the heater unit 22 onto a pair of track brackets 52 that are pre-installed on the underside of the top panel 50 of the housing 12, as shown in FIGS. 10-12. These track brackets 52 may also be installed on the underside of the top panel of a cabinet, as well. In this embodiment, the track brackets 52 include a horizontally oriented panel 54 that may be screwed or otherwise affixed to the underside of the upper panel 50 of the housing 12, and further, the track brackets 52 include a horizontal ledge 56 forming a track that is disposed adjacent and slightly below the horizontally oriented panel 54. Slider brackets 58 are attached to each side of the heater unit 22, as shown in FIGS. 10-12. These slider brackets 58, in one embodiment, include a vertically oriented panel 60 for attachment to the side of the heater unit 22, and each slider bracket 58 includes a horizontally oriented lip 62 that extends outwardly in a direction away from the heater unit 22, as shown. The slider brackets 58 then slidably engage the track brackets 52, where the horizontally oriented lip 62 of each slider bracket 58 slides along the top surface of the track (horizontal ledge 56) formed by the track bracket 52. This embodiment facilitates insertion of the heater unit 22, into the housing after the fireplace insert has been assembled, and further facilitates removal of the heater unit from the housing for repair or replacement, as necessary.

### Flame Simulator Unit

The flame simulator unit 26 is preferably a closed structure that is positioned within the fireplace insert housing 12, and it includes internal components, preferably including in one embodiment, a flame PCB light strip, a blue light PCB light strip, a gray PCB light strip, and optionally, may include a motor component that rotates a flame simulating reflector mechanism that reflects light generated by the PCB light strip to create the flame simulation effect. The motor component may be electrically connected to the electronic control unit, which may further include controls for brightness of the PCB light strips and the speed of the flame simulating mechanism.

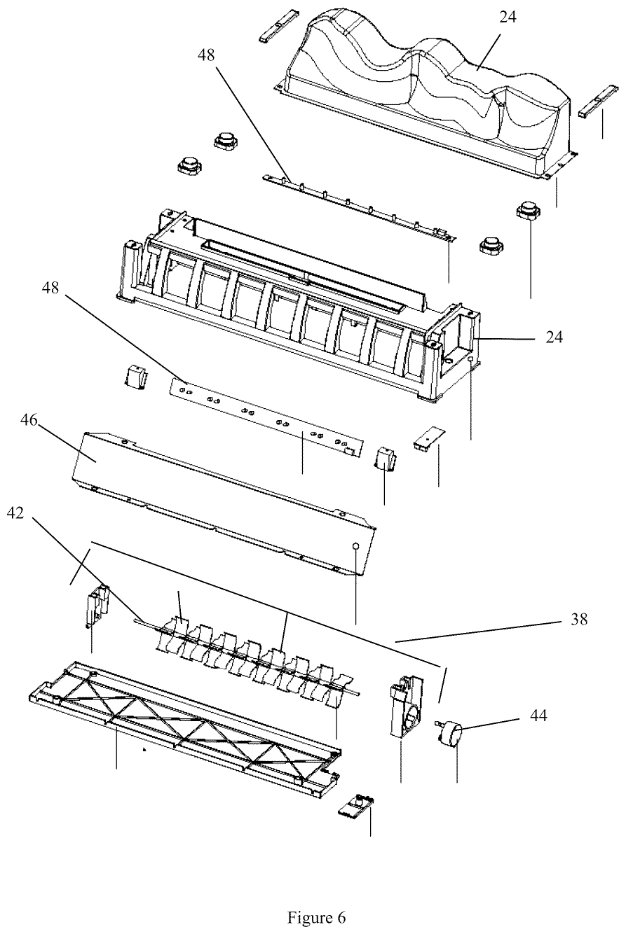

One embodiment of a flame simulator unit 26 is shown in FIG. 6, which includes a base plate 34, a rotating flame simulating mechanism 38 with reflectors 40 attached to a rotating axle, a motor 44 for rotating the axle, a cover plate 46, strip lights 48, a grate and simulated fire logs 24, along with assembly hardware.

It should be understood that other types of lighting may be used to create the flame simulation effect, including LED lights, LED light strips, light bulbs, or any other suitable lighting that is commonly used for such purposes. In some embodiments, the lights themselves create the flame simulator effect, without the necessity of a motorized component that rotates a physical flame simulating mechanism. For example, LED lighting that is commercially available today simply uses a series of LED lights that are programmed to intermittently illuminate in programmed or random patterns, in order to simulate flames or gas lamps, and any such flame simulating lighting may also be used in the present flame simulator unit, as desired.

Other embodiments of flame simulator units are shown and described in the references cited hereinabove and are known in the art, and may be incorporated into the present modular electric fireplace insert.

In one embodiment, the heater unit 22 is formed as a separate component from the flame simulator unit 26, wherein the heater unit is positioned within an upper portion of the fireplace insert housing, and the flame simulator unit is positioned within a lower portion of the fireplace insert housing, as shown in FIGS. 1-5. In this embodiment, the heater unit 22 and the flame simulator 26 unit are electrically connected by any suitable electrical cord so that the electronic controller is operatively connected to both the heater unit 22 and the flame simulator unit 26, in order to control both the heat and the light emanating from the system. A control panel 28 is preferably provided on a front portion of the heater unit 22, although it may be positioned at other desired locations in other embodiments. Both the heater unit 22 and the flame simulator unit 26 may include outlets for receiving the electrical cord, so that a user simply plugs a first end of the cord into the outlet on the heater unit 22, and plugs the second end of the cord into the outlet on the flame simulator unit 26. Alternatively, the cord may be hard wired into either the heater unit 22 or the flame simulator unit 26, and may then be plugged into an outlet in the other unit.

Some of the beneficial effects of this arrangement are that the various heater components can be independently produced and delivered, thus increasing production efficiency, and additionally, this configuration allows the manufacturer to save space and transportation costs by separately packing the heater unit 22 and the flame simulator unit 26 as a space-saving measure. In addition, repairing the individual components (specifically the heater unit 22 or the flame simulator unit 26) is made simpler as each component can be readily and easily replaced without disturbing the other unit.

In a second embodiment, the heater unit 22 and the flame simulator unit 26 may be combined into a single, consolidated component. In this configuration, the heater unit 22 is hardwired to the flame simulator unit 26 within a single sub-housing that includes both the heater unit 22 and the flame simulator unit 26. In this arrangement, the combined heater unit 22 and flame simulator unit 26 are disposed within a bottom portion of the fireplace insert housing 12, but otherwise, the units perform and are controlled in the same manner as described hereinabove.

One of the advantages of this configuration, wherein the heater unit 22 and the flame simulator unit 26 are consolidated into a single component within a sub-housing, there is no requirement for an end-user to electrically connect the heater unit and the flame simulator unit by an electrical cord, thus making assembly and installation of the modular fireplace insert 10 simpler, as those units are already hardwired together in this embodiment.

### Remote Control

It is contemplated that the electronic controller may include, or be operatively connected to, a receiver for wirelessly receiving commands from a remote control unit. The remote control unit may take many forms, including a standard remote control unit that is commonly used to operate televisions, fireplaces, or other similar electronic devices, or the remote control unit may be a mobile telephone, tablet, or the like that includes a software application (commonly referred to as an “app”). The remote control may be used to control the temperature and/or fan speed of the heater unit 22, and may further include controls for the flame simulator unit 26, including brightness, color, flame simulation patterns, and the like.

For assembly of the modular fireplace insert, steps include assembling the housing 12, inserting and installing the heater unit 22 and the flame simulator unit 26 (including any other accessories, such as the fake ash component, for example) within the housing 12. If necessary, for some embodiments, another step in the assembly process is to electrically connect the heater unit 22 and the flame simulator unit 26, although this step is unnecessary for the embodiment wherein the heater unit 22 and the flame simulator unit 26 are consolidated into a single component within a sub-housing. The housing 12 and other components may be assembled in any suitable manner, including screws, clamps, snap fit mechanisms, nuts and bolts, or using any other suitable, commonly known and used assembly mechanisms, in any desired combination.

In a preferred embodiment, the entire modular fireplace insert 10 is shipped to an end user in a disassembled state, and is then assembled by an end user. Preferably, the heater unit 22 and the flame simulator unit 26 are pre-assembled, either separately or together, so that an end user need not assemble those components. Rather, in a preferred embodiment, the heater unit 22 and the flame simulator units 26 only need to be installed within the housing 12, per the instructions provided. Once the entire modular fireplace insert 10 is fully assembled, then the user may plug the power cord into a wall outlet and install the assembled modular fireplace insert 10 into a fireplace, cabinet, wall, or the like.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. An electric modular fireplace insert, comprising:
a fireplace insert housing formed from separate housing components, said housing components including a bottom panel, a right side panel, a left side panel, a back panel and a front glass panel, wherein said fireplace insert housing may be assembled from and disassembled into said separate housing components;
a heater unit removably disposed within said fireplace insert housing, said heater unit including a heating element and a fan;
a fire simulator unit removably disposed within said fireplace insert housing, said fire simulator unit comprising a series of lights, said fire simulator unit being electrically and operationally connected to said heater unit;
an electronic controller operationally connected to said heater unit and said fire simulator unit, said electronic controller being programmed to control said heater unit and said fire simulator unit; and
wherein said electric modular fireplace insert is adapted to be assembled and then installed into a desired location in a fully assembled state.

2. The electric modular fireplace insert set forth in claim 1, wherein said heater unit and said fire simulator unit are hardwired together, and are both disposed within a sub-housing that is removably installed into said fireplace insert housing.

3. The electric modular fireplace insert set forth in claim 1, wherein said heater unit is disposed within an upper portion of said fireplace insert housing, and said flame simulator unit is disposed within a lower portion of said fireplace insert housing, and
wherein said heater unit and said flame simulator unit are connected together by a removable electrical cord.

4. The electric modular fireplace insert set forth in claim 3, wherein said heater unit includes a control panel allowing a user to control temperature of said heating element, and speed of said fan.

5. The electric modular fireplace insert set forth in claim 4, wherein said control panel further allows a user to control said lights within said flame simulator unit.

6. The electric modular fireplace insert set forth in claim 1, further including a wireless receiver that is operatively connected to said electronic controller.

7. The electric modular fireplace insert set forth in claim 6, further including a remote control that is in wireless communication with said wireless receiver, so that said remote control is adapted to operate said electronic controller.

8. The electric modular fireplace insert set forth in claim 1, wherein said heater unit includes a pair of slider brackets disposed on either side thereof, and wherein said housing further includes a top panel;
said top panel having a pair of track brackets affixed to an underside thereof, so that said are slidably engaged with said track brackets, thereby allowing said heater unit to be slidably insertable into said housing after assembly of said electric modular fireplace insert, and further allowing said heater unit to be slidably removable from said housing.
